(19) United States
(12) Patent Application Publication
(10) Pub. No.: US 2001/0055460 A1
(43) Pub. Date: Dec. 27, 2001

(54) Two-dimensional array for rotational alignment of polarization maintaining optical fiber

(76) Inventor: Dan A. Steinberg, Blacksburg, VA (US)

Correspondence Address: JONES VOLENTINE, L.L.C., SUITE 150, 12200 SUNRISE VALLEY DRIVE, RESTON, VA, 20191, US

(21) Appl. No.: 09/824,638

(22) Filed: Apr. 4, 2001

Related U.S. Application Data
(60) Provisional application No. 60/194,680, filed on Apr. 4, 2000.

(51) Int. Cl. G02B 6/36

(52) U.S. Cl. 385/137; 385/11

(57) ABSTRACT

The present invention relates to an optical device having a passive alignment frame with an opening therethrough. The opening has a non-circular cross-sectional shape, and a polarization maintaining optical fiber is disposed in the opening. The polarization maintaining optical fiber is rotationally aligned in the opening and the rotational alignment is maintained. The polarization maintaining optical fiber also has a non-circular cross-sectional shape, which may or may not match the non-circular cross-sectional shape of the opening.

### CROSS-REFERENCE TO RELATED APPLICATIONS

The present invention claims priority from U.S. Provisional patent application Ser. No. 60/194,680 entitled “2-dimensional fiber arrays for noncircular, polarization maintaining optical fiber”, filed Apr. 4, 2000. The disclosure of the above captioned patent application is specifically incorporated by reference as though reproduced in its entirety herein.

### FIELD OF THE INVENTION

The present invention relates generally to optical fiber arrays, and specifically to two-dimensional polarization maintaining optical fiber (PMF) arrays.

### BACKGROUND OF THE INVENTION

Optical communications is evolving as a chosen technique for many communication systems. Typically, optical fibers are used as the medium for carrying optical signal between points of transmission, reception and amplification.

Often, it is desirable to send and receive optical signals in defined states of polarization. Maintaining the state of polarization may be difficult and any transformation of the desired polarization state to another polarization state may result in a type of dispersion known as polarization mode dispersion (PMD). Polarization mode dispersion can significantly impact the reliability of an optical signal. For example, in a digital optical communication system, polarization mode dispersion may significantly impact the bit error rate (BER).

One useful way of maintaining the polarization of a particular optical signal in an optical communication system is through the use of polarization maintaining fiber (PMF). PMF is designed so that the polarization of a particular signal does not substantially change with distance. Often PMF is used for short distance interconnections between optical components that have polarization dependencies. For example, PMF may be used to link lasers to external modulators that are polarization dependent.

While polarization maintaining fiber has proven to be a valuable asset in a variety of applications, to be useful the PMF must have a substantially fixed orientation. Otherwise, the state of polarization may be dependent on the rotational orientation of PMF at a particular location. The potential for error due to mis-orientation is magnified in multiple fiber structures, such as fiber arrays.

What is needed, therefore, is an apparatus for maintaining the orientation of polarization maintaining fiber so that the rotational orientation of the desired state of polarization is maintained in an optical fiber array.

### SUMMARY OF THE INVENTION

It is an object of the present invention to provide a structure for achieving and maintaining rotational alignment of polarization maintaining optical fiber, so that the orientation of a particular polarization vector of an optical signal traversing the polarization maintaining optical fiber is substantially maintained in a particular orientation.

To accomplish the above and other objectives, an optical device includes a passive alignment frame having an opening therethrough. The opening has a non-circular cross-sectional shape. A polarization maintaining optical fiber (PMF) is disposed in the opening. The polarization maintaining optical fiber also has a non-circular cross-sectional shape.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIGS. 1(a)-1(d) are front views of passive alignment frames having openings therethrough which receive of polarization maintaining optical fiber according to exemplary embodiments of the present invention.

FIGS. 2(a)-2(c) are cross-sectional views showing fabrication of an opening insertion in a passive alignment frame according to an illustrative embodiment of the present invention.

FIGS. 3 is a cross-sectional view showing insertion of a polarization maintaining optical fiber in an opening of a passive alignment frame according to an exemplary embodiment of the present invention.

### DETAILED DESCRIPTION

In the following detailed description, for purposes of explanation and not limitation, exemplary embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

Briefly, the present invention relates to an optical device having a passive alignment frame with an opening therethrough. The opening has a non-circular cross-sectional shape, and a polarization maintaining optical fiber having a non-circular cross-sectional shape is disposed in the opening. Advantageously, rotational alignment of the polarization maintaining optical fiber is achieved and maintained by the passive alignment frame according to an exemplary embodiment of the present invention.

The cross-sectional shapes of the openings described in connection with the exemplary embodiments described below are illustrative and not intended to be limiting. Generally, the cross-sectional shapes of the openings have 180° symmetry or 360° symmetry. As used herein, 180° symmetry means that rotation of 180° about an axis of rotation is required for a shape having a particular orientation before the rotation to “return” to this particular orientation. Similarly, 360° symmetry means that full (360°) rotation about an axis of rotation is required for a shape having a particular orientation before the rotation to “return” to this particular orientation. (A shape having 360° symmetry may also be viewed as having no symmetry). For example, a rectangle exhibits 180° symmetry; while a D-shaped cross-section exhibits 360° symmetry. Finally, it is of interest to note that the cross-sectional shape of the PMF and the opening(s) in the passive alignment frame may or may not substantially match. A useful aspect of the present invention is rotational alignment and maintenance of the rotational alignment of the PMF by the passive alignment frame. This may be achieved according to exemplary embodiments where the cross-sectional shape of the opening(s) in the passive alignment frame is substantially the same as the cross-sectional shape of the optical fiber rotationally aligned therein. Alternatively, this may be achieved according to exemplary embodiments where the cross-sectional shape of the opening(s) in the passive alignment frame substantially different than the cross-sectional shape of the PMF. For example, a PMF having a D-shaped cross-section could be rotationally aligned in a substantially rectangular cross-section opening in a passive alignment frame according to an exemplary embodiment of the present invention.

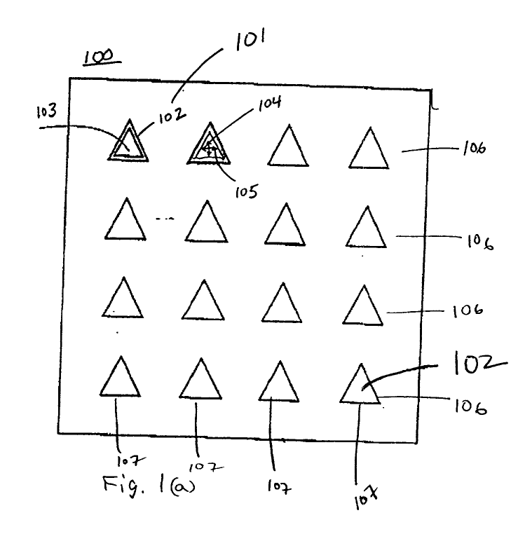

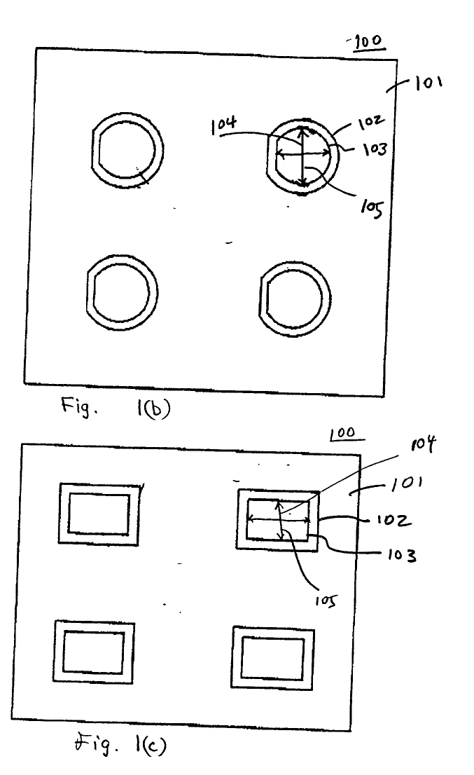

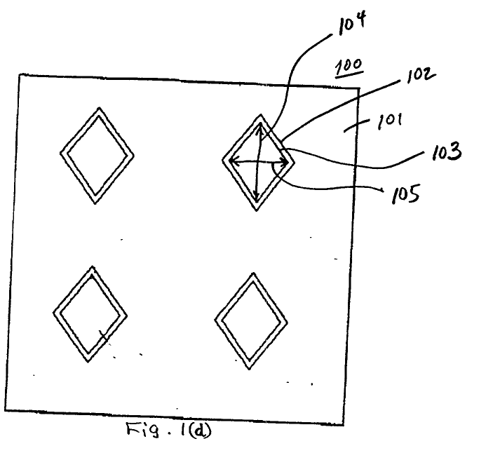

FIG. 1(a) is a front view of an optical fiber array 100. A passive alignment frame 101 has openings 102 with polarization maintaining (PM) optical fibers 103 disposed in the openings 102. As illustrated, the fiber array 100 has a series of rows 106 and a series of columns 107. In the particular illustrative embodiment of FIG. 1(a), a 4×4 fiber array 100 is shown. The 4×4 array is clearly symmetrical, with an equal number of rows 106 and columns 107. Of course, the number of rows 106 and number of columns 107 is completely variable. Moreover, the number of rows and columns are not necessarily equal.

In the illustrative embodiments of FIGS. 1(a)-1(d), a variety of cross-sectional shapes for openings 102 are shown. In each embodiment, the cross-sectional shape of the openings in a particular passive alignment frame 101 is the same. Of course, the is illustrative, and it is entirely possible that a particular alignment frame 101 includes openings 102 having on or more dissimilar cross-sectional shapes. For example, openings 102 having a rectangular shape (shown in FIG. 1(c)) may be combined on the same passive alignment frame 101 with openings 102 having a substantially D-shape (shown in FIG. 1(b)). Again, these are merely illustrative of the shapes of the openings 102 that may be used in carrying out the invention. As referenced above, openings 102 of a variety of shapes having 180° symmetry or 360° symmetry may be used in carrying out the invention of the present disclosure.

In the illustrative embodiment of FIG. 1(a) the polarization maintaining (PM) optical fibers 103 have a substantially triangular cross-section. However, in keeping with the discussion related to the needed 180° or 360° symmetry of the shapes of the openings, the triangular shape should not be an equilateral triangle. The triangular shape would be selected so that the fibers can only fit in the hole with a certain rotational orientation. For example, the triangular shaped may be isosceles. The PM optical fibers 103 are held by the passive alignment frame 101. As described previously, the openings 102 have cross-sectional shapes that are substantially non-circular. Moreover, the openings 102 may or may not have a cross-sectional shape that is substantially identical to the cross-sectional shape of the polarization maintaining optical fibers 103. In either case, by virtue of the illustrative embodiments of the present invention, the location and rotational orientation of the openings 102 are accurately defined.

The illustrative embodiments of FIGS. 1(b)-1(d) show polarization maintaining optical fibers 103 disposed in openings 102 having D-shaped, rectangular shaped and diamond shaped cross-sections, respectively. Again, these cross-sectional shapes are merely illustrative, and the openings 102 may have other cross-sectional shapes with 180° or 360° symmetry described above. The passive alignment frame 101 of each of these embodiments has openings 102 with respective cross-sectional shapes. As these openings are fabricated and function a similar way to the illustrative embodiment of FIG. 1(a), details of their fabrication and function are omitted in the interest of brevity.

As referenced above, polarization maintaining optical fiber refers to a class of linearly birefringent single mode fiber. Polarization maintaining optical fibers 103 are typically used to guide linearly polarized light from point to point, illustratively between a laser diode and a lithium-niobate modulator in a high-speed telecommunication system. PMF also finds many specialized applications in lightwave communication and optical sensor applications.

The birefringence of PMF is typically much larger and more uniform than any residual birefringence of ordinary single mode fiber. Because the birefringence is associated with a systematic, physical asymmetry of the fiber cross-section, PMF exhibits distinct fast and slow principle optical axes. Illustratively, polarization maintaining optical fibers 103 have first principle axes 104 and a second principle axes 105. These axes generally are the fast and slow axes of the PMF. Light coupled into a length of PMF 103 resolves into two orthogonal, linearly polarized modes, according to how the input electric field of the light projects onto the fast and slow axes of the optical fiber. Advantageously, linearly polarized light is aligned with one of the axes, commonly the slow axis.

Only when a particular electric field vector of light is entirely aligned with the slow or fast axis is PMF truly polarization maintaining. To this end, because of the difference in the index of refraction between the fast and slow axes, electric fields in the two axes are phase-shifted relative to one another in proportion to the distance traveled. If the electric field components exist in both axes (particularly axes 104 and 105 in FIGS. 1(a)-1(d)) the polarization state of the propagating light evolves as it travels through the fiber's lengths and the light exits the fiber at an arbitrary polarization state. As such, it is important to assure the alignment of the fast or slow axis of the optical fiber with the electric field of light traveling therethrough. Moreover, if a polarization maintaining optical fiber is rotated, the mis-orientation of the particular fast or slow axis will result. As such, the electric field vector of the polarized light and a particular fast or slow axis will no longer be properly oriented, and the desired state of polarization of the optical signal will not be maintained.

According to the illustrative embodiments of FIGS. 1(a)-1(d), the passive alignment frame 101 of the exemplary embodiments rotationally aligns (and maintains the rotational alignment of) the polarization maintaining fibers 103 in openings 102 by having the cross-sectional shapes of the polarization maintaining fibers 103 match the cross-sectional shapes of the openings 102. As such, there is a fixed alignment of polarization maintaining fibers 103, and therefore of first and second principle axes 104 and 105, respectively, relative to the opening. Thus, if it is desired to have the electric field vector oriented along either first principle axis 104 or second principle axis 105, in the array, the orientation of the opening 102 relative to PMF 103 would be assured. As described previously, the cross-sectional shape of openings 102 of the passive alignment frame do not necessarily have to match the cross-sectional shape of the PM fibers 103 to achieve and maintain the rotational alignment of the PM fiber 103, and therefore, of first principle axis 104 and second principle axis 105.

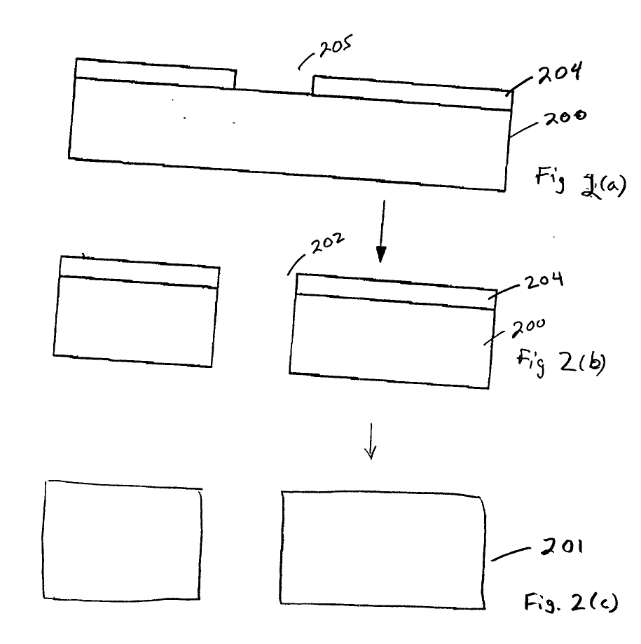

Turning now to FIG. 2(a)-2(c), an illustrative fabrication sequence is shown. In the illustrative embodiment of FIGS. 2(a)-2(c), a substrate 200 is used to form the alignment frame 201. In the illustrative embodiment, the substrate 200 is a material which is readily etched by standard technique precisely to form an opening 202. For purposes of illustration, the substrate 200 may be monocrystalline silicon, silicon, silicon-on-insulator, or other material which has thermal expansion characteristics that are similar to that of a polarization maintaining optical fiber (PMF) to be disposed in opening 202.

As shown in FIG. 2(a), a suitable mask 204 is patterned with an opening 205. A standard etch technique, such as reactive ion etching (RIE), is carried out as shown in FIG. 2(b). The RIE step results in the formation of an opening 202 through the substrate 200. Thereafter as shown in FIG. 2(c), the mask 204 is removed by standard technique and the passive alignment member 201 results. As can be appreciated, the above described technique may be implemented in large scale across a wafer resulting in the formation of an array of openings as described above. It is of interest to note that the openings 202 may have a taper (i.e. be funnel-shaped) for ease of fiber insertion. Illustratively, the opening would be wider at the end where the fiber is inserted, tapering to a narrower width at the opposite end.

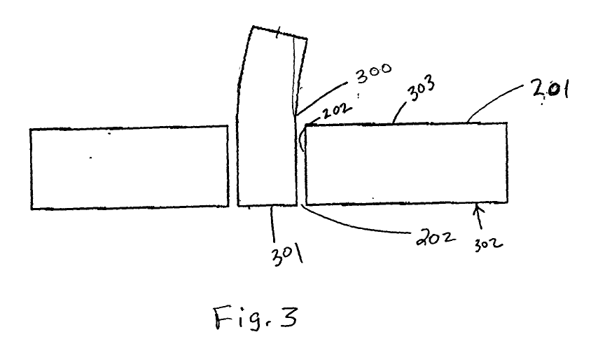

Applicants have found a particularly useful technique for inserting fibers into openings 202 formed according to the illustrative fabrication sequence of FIGS. 2(a)-2(c). FIG. 3 shows such an illustrative insertion sequence. The polarization maintaining optical fiber (PMF) 300 is usefully inserted into opening 202 so that a fiber endface 301 is on a side 302 of the alignment frame 201 that was masked during reactive ion etching. This has been found to provide the most accurate fiber positioning and alignment because the opening 202 is most accurately defined on the side that was masked. To this end, over-etch may result as the opening 202 is made down through to the unmasked side 303. This over-etch can result in opening 202 having a greater width on the unmasked side 303 of the alignment frame 201. Ultimately, this could be a source of undesirable mis-orientation of the PMF 300.

The invention having been described in detail in connection through a discussion of exemplary embodiments, it is clear that various modifications of the invention will be apparent to one having ordinary skill in the art having had the benefit of the present disclosure. Such modifications and variations are included within the scope of the appended claims.

We claim:

1. An optical device, comprising:
A passive alignment frame having an opening therethrough, said opening having a non-circular cross-sectional shape; and
a polarization maintaining fiber disposed in said opening, said polarization maintaining fiber having a non-circular cross-sectional shape.

2. An optical device as recited in claim 1, wherein said non-circular cross-sectional shape of said opening and said non-circular cross-sectional shape of said polarization maintaining optical fiber are different.

3. An optical device as recited in claim 1, wherein said passive alignment frame is of a material chosen from the group consisting essentially of monocrystalline silicon, silicon and silicon-on-insulator (SOI).

4. An optical device as recited in claim 1, wherein said non-circular cross-sectional shape of said opening and said non-circular cross-sectional shape of said polarization maintaining optical fiber are substantially the same.

5. An optical device as recited in claim 1, wherein said passive alignment frame has a first side and a second side, and said first side is masked during formation of said opening; and said polarization maintaining optical fiber has an endface which is substantially co-planar with said second side.

6. An optical device as recited in claim 1, wherein said cross-sectional shape of said opening has 180° symmetry.

7. An optical device as recited in claim 1, wherein said cross sectional shape of said opening has 360° symmetry.

8. An optical device, comprising:
A passive alignment frame having at least two openings therethrough, each of said openings having a non-circular cross-sectional shape; and
a polarization maintaining fiber disposed in each of said openings, each of said polarization maintaining fibers having a non-circular cross-sectional shape.

9. An optical device as recited in claim 8, wherein said non-circular cross-sectional shapes of said at least two openings are substantially identical.

10. An optical device as recited in claim 8, wherein said non-circular cross-sectional shape of one said at least two openings is different than said non-circular cross-sectional shape of another of said at least two openings.

11. An optical device as recited in claim 8, wherein said passive alignment frame further comprises at least one row of said at least two openings.

12. An optical device as recited in claim 8, wherein said passive alignment frame further comprises at least one column of said at least two openings.

13. An optical device as recited in claim 8, wherein said passive alignment frame further comprises n-rows and m-columns of said at least two openings, where n and m are integers.

14. An optical device as recited in claim 13, wherein n=m.

15. An optical device as recited in claim 13, wherein n≢m.

16. An optical device as recited in claim 8, wherein said passive alignment frame is of a material chosen from the group consisting essentially of monocrystalline silicon, silicon and silicon-on-insulator.

17. An optical device as recited in claim 8, wherein said non-circular cross-sectional shape of at least one of said at least two openings is substantially the same as said non-circular cross-sectional shape of said polarization maintaining optical fiber therein.

18. An optical device as recited in claim 8, wherein said non-circular cross-sectional shape of at least one of said at least two openings is substantially different than said non-circular cross-sectional shape of said polarization maintaining optical fiber therein.

19. An optical device as recited in claim 8, wherein said passive alignment frame has a first side and a second side, and said first side is masked during formation of said at least two openings; and each of said polarization maintaining fibers has an endface which is substantially co-planar with said second side.
